(19) United States
(12) Patent Application Publication
(10) Pub. No.: US 2009/0305205 A1
(43) Pub. Date: Dec. 10, 2009

(54) Tottie Trainer

(76) Inventor: Dennis Mark Hicks, Raleigh, NC (US)

Correspondence Address: Dennis Mark Hicks, 3302 Poole RD, Raleigh, NC, 27610, US

(21) Appl. No.: 12/316,672

(22) Filed: Apr. 3, 2009

Related U.S. Application Data
(60) Provisional application No. 61/131,381, filed on Jun. 9, 2008.

(51) Int. Cl. G09B 19/00; G09B 23/00

(52) U.S. Cl. 434/236; 434/247; 434/263

(57) ABSTRACT

Programmable potty training device attachable to child, reminding Toddler to not forget potty time after meals. Accordingly, persuading child to go to restroom. Device attached to child activates device in restroom relaying charismatic character teaching sanitary proper potty training techniques.

This concept promotes successful potty training. It requires a digital wristband and digital base unit interactively sending/receiving commands. The wristband character reminds the child to potty. This inspires the child to go to the bathroom where the wristband interacts and comes alive with a character walking the child through proper sitting/standing position, sanitary wiping, flushing, and hand washing procedures. This corresponds with the schedule of the child's meals.

The base station operates according to gender and procedures for potty training. The wristband character will be an unconditional friend giving proper, enjoyable explanations to the child on how to use the bathroom. It will have a game like feel that teaches responsible potty training techniques.

This takes pressure off of the parents, saves on diapers, and reduces diapers in the landfill. This technique is a positive, unique idea never done before now, and will expedite potty training for kids and parents.

It is claimed:

1. A wristband with talking characters that interact electronically with a sub-base for the purpose of teaching a child proper potty training procedures.

2. A wristband with talking characters that interact electronically with a sub-base for the purpose of teaching a child to go outside and play.

3. A wristband with talking characters that interact electronically with a sub-base for the purpose of teaching a child proper procedures for brushing their teeth.

4. A wristband with talking characters that interact electronically with a sub-base for the purpose of teaching discipline and time out.

5. A wristband with talking characters that interact electronically with a sub-base for the purpose of teaching exercises.

6. A wristband with talking characters that interact electronically with a sub-base for the purpose of reminding a child to do homework.

7. A wristband with talking characters that interact electronically with a sub-base for the purpose of teaching personal hygiene and bathing procedures.
